(19) United States
(12) Patent Application Publication
(10) Pub. No.: US 2007/0019765 A1
(43) Pub. Date: Jan. 25, 2007

(54) Method of measuring inter-symbol interference and apparatus therefor

(76) Inventor: David Martin Gee, Manningtree (GB)

Correspondence Address: LOWE HAUPTMAN BERNER, LLP, 1700 DIAGONAL ROAD, SUITE 300, ALEXANDRIA, VA, 22314, US

(21) Appl. No.: 11/345,518

(22) Filed: Feb. 2, 2006

(30) Foreign Application Priority Data
Feb. 3, 2005 (GB) 0502184.5

(51) Int. Cl. H04L 7/00

(52) U.S. Cl. 375/354

(57) ABSTRACT

Inter-Symbol Interference is measured in fibre-optic communications systems by using the statistically balanced nature of the data being communicated and correlating a received data signal with a time-delayed version of the data signal to obtain an error signal. The error signal drives an adaptive equaliser to achieve channel equalisation.

### RELATED APPLICATIONS

The present application is based on, and claims priority from, Great Britain Application Number 0502184.5, filed Feb. 3, 2005, the disclosure of which is hereby incorporated by reference herein in its entirety.

### FIELD OF THE INVENTION

The present invention relates to a method of measuring Inter-Symbol Interference, for example of the type occurring in non-wireless communications systems, such as those supported by wire-line communications links, for example, a fibre-optic communications link. The present invention also relates to an apparatus for measuring Inter-Symbol Interference, and adaptive equaliser apparatus, an optical receiver and an optical communications system employing the above-mentioned apparatus for measuring Inter-Symbol Interference.

### BACKGROUND OF THE INVENTION

In the field of optical communications, it is known to employ an optical transmitter to modulate light of one or more predetermined wavelength to communicate data to an optical receiver separated from the optical transmitter by a length of optical fibre.

As part of a continued drive to extend electrically the optical transmission distance of data transmitted at a data rate of 10 Gb/s over multi-mode optical fibre, it is initially desirable to achieve lossless data transmission at 10 Gb/s per second over 300 metres of optical fibre.

Inter-Symbol Interference (ISI) is one significant hindrance in achieving transmission over the above-mentioned distance at such a high data rate. Consequently, it is known to employ so-called adaptive equalisers that can be adaptively configured in the presence of changing channel conditions in order to compensate for ISI. In order to adapt, adaptive equalisers require a goal to drive an adaptive algorithm of the equaliser, for example measured information about a transmission channel associated with the equaliser. This typically involves the use of a training sequence, such as a predetermined bit stream in order to discover characteristics of the transmission channel. However, use of the training sequence requires agreement between ends of a communications link as well as industry standardisation.

Alternatively, the goal can be provided in the form of an error signal to serve as a measure of the quality, i.e. freedom from errors of received, or equalised, data. In this respect, error signals can be used to measure degradation of signals either before or after equalisation. One known technique involves measurement of a Bit Error Rate (BER), i.e. the number of bits per second that are in error. In terms of a protocol stack associated with the communications link, the BER measure is carried out at a relatively high layer of the protocol stack. Another technique for generating the error signal employs a Clock and Data Recovery (CDR) technique to analyse the so-called Eye Mask Margin using early and late, or high and low, sampling points in addition to normal CDR sampling points targeted at a centre on an “eye” of a data signal. However, the above technique employs an unacceptably high degree of complexity, requiring access to the CDR, entire data packets or a higher level protocol.

### SUMMARY OF THE INVENTION

According to a first aspect of the present invention, there is provided a method of measuring Inter-Symbol Interference in a non-wirelessly received bit stream, the method comprising the steps of: receiving the bit stream; generating a delayed version of the bit stream; and correlating bits at a number of bit positions of the received bit stream with bits at a same number of bit positions of the delayed version of the bit stream so as to form an indication of Inter-Symbol Interference.

The method may further comprise the step of averaging the correlation over a predetermined period of time.

The bits at a number of bit positions and the bits at a same number of bit positions may be serial.

The bit stream may be a receiver input signal.

The method may further comprise the step of deconvolving the indication of the Inter-Symbol Interference.

The method may further comprise a steps of: generating another delayed version of the bit stream; and correlating the bits at a number of bit positions of the received bit stream with another same number of bit positions of the another delayed version of the bit stream so as to form another indication of the Inter-Symbol Interference. The method may further comprise the step of: determining from the indication of the Inter-Symbol Interference and the another indication of the Inter-Symbol Interference an extent of the Inter-Symbol Interference in terms of unit intervals.

The bit stream may be an equaliser and output signal.

According to a second aspect of the present invention, there is provided an Inter-Symbol Interference measurement apparatus comprising: an input for receiving a bit stream; a delay for generating a delayed version of the bit stream; a correlator for correlating bits at a number of bit positions of the received bit stream with bits at a same number of bit positions of the delayed version of the bit stream, the correlation constituting an indication of Inter-Symbol Interference.

The correlator may be arranged to average over a predetermined period of time. The correlator may comprise a multiplier. The correlator may further comprise a filter coupled to the multiplier so as to average the correlation over a predetermined period of time.

According to a third aspect of the present invention, there is provided an adaptive equaliser apparatus comprising the Inter-Symbol Interference measurement apparatus as set forth above in relation to the second aspect of the present invention.

The adaptive equaliser apparatus may comprise filter coefficients, the adaptive equaliser being arranged to adapt the filter coefficients in response to the indication of the Inter-Symbol Interference.

According to a fourth aspect of the present invention, there is provided an optical receiver comprising the Inter-Symbol Interference measurement apparatus as set forth above in relation to the second aspect of the present invention.

According to a fifth aspect of the present invention, there is provided an optical communications system comprising the Inter-Symbol Interference measurement apparatus as set forth above in relation to the second aspect of the present invention.

It is thus possible to provide a method of measuring Inter-Symbol Interference and apparatus therefor that can, relatively simply, generate an error signal that does not require access to a CDR, entire data packets of higher-level protocols. Consequently, the equaliser apparatus does not have to be co-located with the CDR and so a recovered clock signal is not required to measure a received signal, thereby enabling the equaliser to be clockless. Furthermore, the apparatus and method enable existing equaliser architectures to be re-used to generate one or more error signal to indicate the presence of Inter-Symbol Interference. Also, the apparatus and method can be effectively merged into standard equaliser structures, thereby obviating the need for additional large, high-speed, high-power circuitry.

### BRIEF DESCRIPTION OF THE DRAWINGS

At least one embodiment of the invention will now be described, by way of example only, with reference to the accompanying drawings, in which:

FIG. 1 is a schematic diagram of a Finite Impulse Response equaliser employing an Inter-Symbol Interference estimation technique and constituting an embodiment of the invention;

FIG. 2 is a schematic diagram of a Decision Feedback Equaliser employing the Inter-Symbol Interference estimation technique and constituting another embodiment of the invention;

FIGS. 3A to 3C are graphs illustrating operation of the apparatus of FIG. 2 in a first operative state;

FIGS. 4A to 4C are graphs illustrating operation of the apparatus of FIG. 2 is a second operative state;

FIGS. 5A to 5C are graphs illustrating operation of the apparatus of FIG. 2 in a third operative state; and

FIG. 6 is a schematic diagram of another Decision Feedback Equaliser constituting another embodiment of the invention.

### DETAILED DESCRIPTION OF THE DRAWINGS

Throughout the following description identical reference numerals will be used to identify like parts.

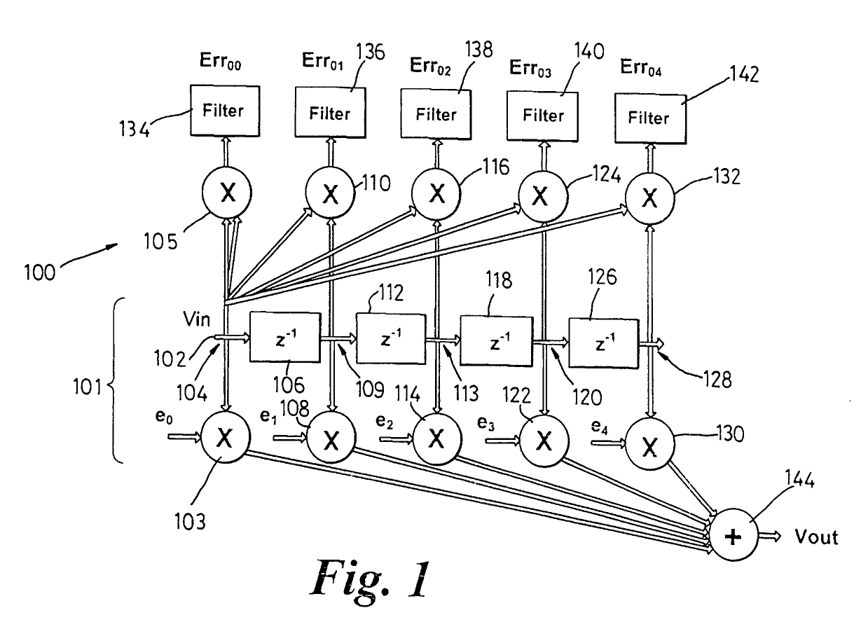

Referring to FIG. 1, an opto-electronic receiver (not shown) comprises a Finite Impulse Response (FIR) adaptive equaliser 100 having an adaptive equaliser part 101 that includes an input 102 for receiving a bit stream, for example a receiver input signal (not shown), the input 102 being coupled to a first input of a first multiplier 103 via a first tap 104 and a first input of a second multiplier 105, as well as an input of a first delay 106. An output of the first delay 106 is coupled to a first input of a third multiplier 108 via a second tap 109, a first input of a fourth multiplier 110 and an input of a second delay 112. An output of the second delay 112 is coupled, via a third tap 113, to a first input of a fifth multiplier 114, a first input of a sixth multiplier 116 and an input of a third delay 118. An output of the third delay 118 is coupled, via a fourth tap 120, to a first input of a seventh multiplier 122, a first input of an eighth multiplier 124 and an input of a fourth delay 126. An output of the fourth delay 126 is coupled, via a fifth tap 128, to a first input of a ninth multiplier 130 and a first input of a tenth multiplier 132.

The input 102 is also coupled, via the first tap 104, to a second input of the second multiplier 105, as well as respective second inputs of the fourth, sixth, eighth and tenth multipliers 110, 116, 124, 132. In addition, a first filter 134 is coupled to an output of the second multiplier 105, a second filter 136 is coupled to an output of the fourth multiplier 110, a third filter 138 is coupled to an output of the sixth multiplier 116, a fourth filter 140 is coupled to an output of the eighth multiplier 124, and a fifth filter 142 is coupled to an output of the tenth multiplier 132. In this example, the first, second, third, fourth and fifth filters 134, 136, 138, 140, 142 are RC filters to provide an average over a predetermined period of time.

As is common with FIR equalisers, second inputs of the first, third, fifth, seventh and ninth multipliers 103, 108, 114, 122, 130 are respectively coupled to sources (not shown) of a first weight, e₀, a second weight, e₁, a third weight, e₂, a fourth weight, e₃, and a fifth weight, e₄. These are known as tap weights. Outputs of the first, third, fifth, seventh and ninth multipliers 103, 108, 114, 122, 130 are coupled to a summation unit 144, an output of which provides an equalised output signal.

In operation, the input 102, the first, second, third and fourth delays 106, 112, 118, 126, the first, third, fifth, seventh and ninth multipliers 103, 108, 114, 122, 130 and the summation unit 144 constitute the adaptive equaliser part 101 of the FIR equaliser 100. This is a known adaptive equaliser architecture that operates in a known manner. Consequently, for the sake of conciseness and clarity of description, this part of the FIR equaliser will not be described in further detail.

In relation to the inter-operability of the first, second, third and fourth delays 106, 112, 118, 126 with the multiplier-filter combinations 105, 134; 110, 136; 116, 138; 124, 140; 132, 142, upon receipt of the bit stream at the input 102, a first delayed version of the bit stream is generated by the first delay 106, a second delayed version of the bit stream is generated by the second delay 112, a third delayed version of the bit stream is generated by the third delay 118 and a fourth delayed version of the bit stream is generated by the fourth delay 126. The bit stream and the first, second, third and fourth delayed versions of the bit stream are available at the first, second, third, fourth and fifth taps 104, 109, 113, 120, 128, and indeed are used by the adaptive equalisation part 101 of the FIR equaliser 100.

However, the second multiplier 105 also receives, via the first tap 104, the tapped bit stream at the first and second inputs of the second multiplier 105, the second multiplier 105 correlating the signals at the first and second inputs thereof and the results of the correlation, at the output of the second multiplier 105 being averaged over a predetermined period of time by the first filter 134.

The bit stream, taken from the first tap 104 is also correlated with the first delayed version of the bit stream taken from the second tap 109 by the fourth multiplier 110. The result of the correlation performed by the fourth multiplier 110 is averaged over the predetermined period of time by the second filter 136.

The sixth multiplier 116 also correlates the bit stream, taken from the first tap 104, with the second delayed version of the bit stream taken from the second tap 109. The output of the sixth multiplier 116 is averaged over the predetermined period of time by the third filter 138.

The eighth multiplier 124 also correlates the bit stream, taken from the first tap 104, with the third delayed version of the bit stream taken from the fourth tap 120. The output of the eighth multiplier 124 is averaged over the predetermined period of time by the fourth filter 140.

The tenth multiplier 132 also correlates the bit stream, taken from the first tap 104, with the fourth delayed version of the bit stream taken from the fifth tap 132. The output of the tenth multiplier 132 is averaged over the predetermined period of time by the fifth filter 142.

The first, second, third, fourth and fifth filters 134, 136, 138, 140, 142 consequently generate a respective first, second, third, fourth and fifth error signals Err₀₀, Err₀₁, Err₀₂, Err₀₃, Err₀₄. The first error signal, Err₀₀ corresponds to a self-correlation of the bit stream.

The second error signal, Err₀₁, corresponds to the correlation of the bit stream with the first delayed version of the bit stream, averaged over the predetermined period of time and constitutes a first measure of Inter-Symbol Interference (ISI). Similarly, the third error signal, Err₀₂, in a like manner to the second error signal, Err₀₁, constitutes a second measure of the ISI. Likewise, the fourth error signal, Err₀₃, constitutes a third measure of the ISI and the fifth error signal, Err₀₄, constitutes a fourth measure of the ISI.

In relation to each measure of the ISI, the bit stream for the optical communications system is required to be balanced, i.e. statistically, to contain as many 1's as 0's, and to be scrambled or random. Consequently, very little or no correlation should exist between the bit stream and delayed versions of the bit stream if no ISI is present in the bit stream. The first, second, third and fourth delays 106, 112, 118, 126 respectively represent delays of 1 bit period or interval, 2 bit periods or intervals, 3 bit periods or intervals and 4 bit periods or intervals relative to the bit stream.

By correlating the bit stream with versions of itself at different bit period delays, it is possible to establish the “depth”, or number of bit periods over which the ISI extends, i.e. between 1 and 4 bit periods.

In response to one or more of the second, third, fourth or fifth error signals Err₀₂, Err₀₂, Err₀₃, Err₀₄ the filter coefficients e₀, e₁, e₂, e₃, e₄ are set to reduce or possibly obviate entirely the ISI present in the bit stream.

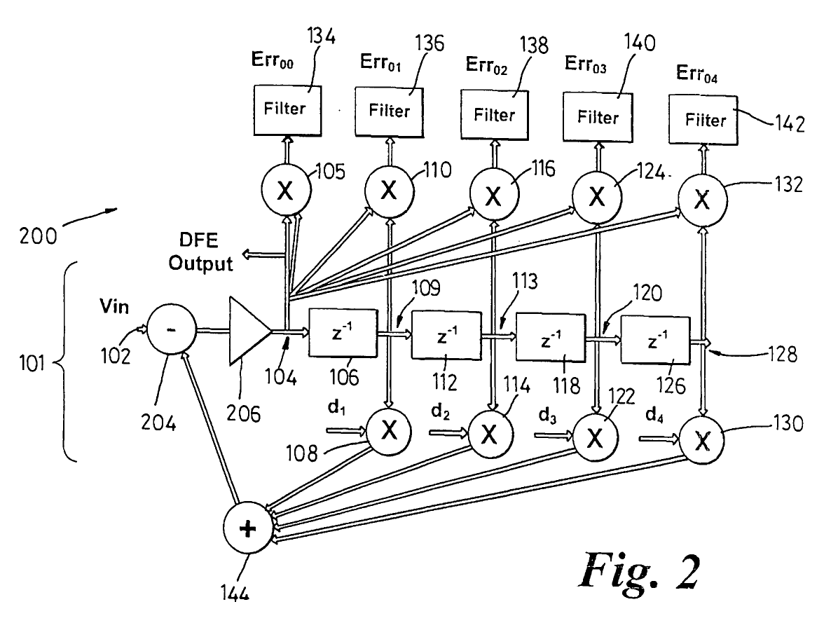

Turning to FIG. 2, a second embodiment employs the ISI estimation technique in a Decision Feedback Equaliser (DFE) 200. The DFE 200 comprises the adaptive equalisation part 101, which comprises the first, second, third and fourth delays 106, 112, 118, 126 coupled to the third, fifth, seventh and ninth multipliers 108, 114, 122, 130 of the FIR equaliser 100 of FIG. 1, and also the first, second, third, fourth and fifth taps 104, 109, 113, 120, 128. However, the adaptive equalisation part 101 of the DFE 200 does not comprise the first multiplier 103 coupled to the first tap 104, the remaining third, fifth, seventh and ninth multipliers 108, 114, 122, 130 being coupled to the summation unit 144.

In this embodiment, the summation unit 144 is coupled to a first input of a subtractor 204, a second input of the subtractor 144 being coupled to the input 102 for receiving the bit stream. An output of the subtractor 204 is coupled to an input of a quantiser 206, an output of the quantiser 206 being coupled to the first delay 106, the first tap 104 being between the output of the quantiser 206 and the input of the first delay 106. In a like manner to the FIR adaptive equaliser 100 of FIG. 1, the DFE 200 is adaptively configurable using first, second, third and fourth tap weights d₁, d₂, d₃, d₄. Additionally, the first tap 104 is used to provide a DFE output signal.

In the same way as for the FIR equaliser 100, the DFE 200 comprises the second, fourth, sixth, eighth and tenth multipliers 105, 110, 116, 124, 132 respectively coupled to the first, second, third, fourth and fifth filters 134, 136, 138, 140, 142 to provide the first, second, third, fourth and fifth error signals Err₀₀, Err₀₁, Err₀₂, Err₀₃, Err₀₄.

In operation the adaptive equaliser part 101 of the DFE 200 operates in accordance with the normal operating regime of such a circuit and so will not be described further for reasons of clarity and conciseness of description.

In relation to the ISI estimation provided by the second, fourth, sixth, eighth and tenth multipliers 105, 110, 116, 124, 132 respectively coupled to the first, second, third, fourth and fifth filters 134, 136, 138, 140, 142, the first, second, third, fourth and fifth error signals Err₀₀, Err₀₁, Err₀₂, Err₀₃, Err₀₄ are provided in the same way as in relation to the FIR equaliser 100 and constitute the respective second, third, fourth and fifth measurements of the ISI that can be used to adapt the first, second, third and fourth tap weights d₁, d₂, d₃, d₄.

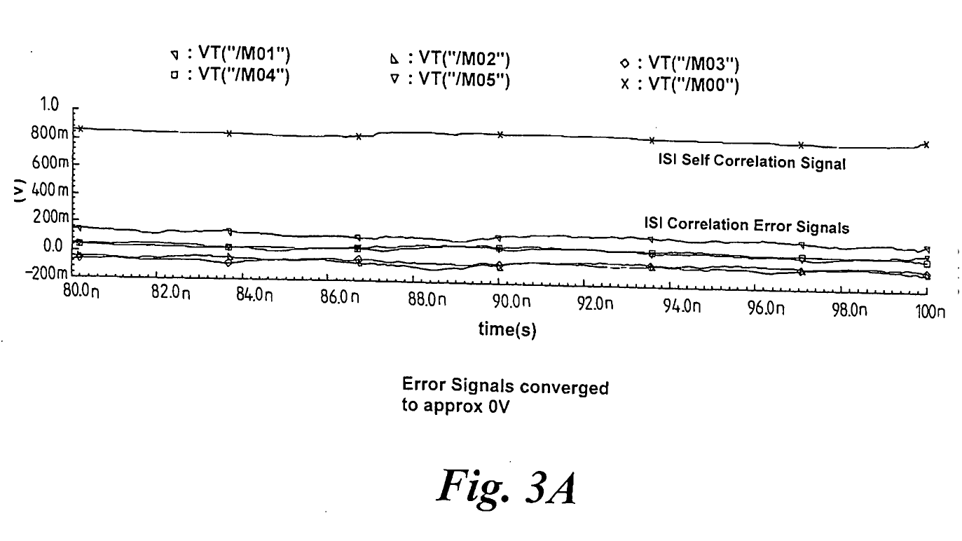

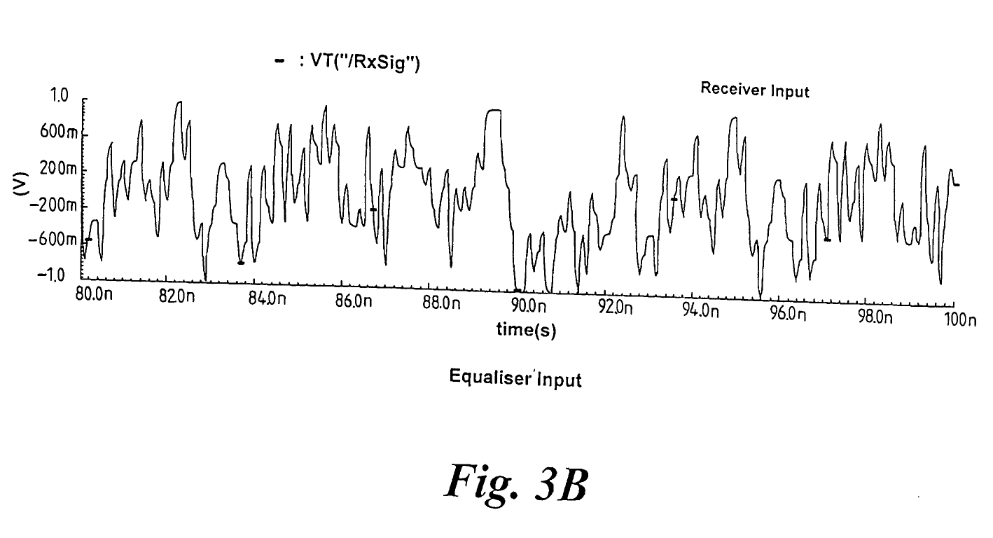

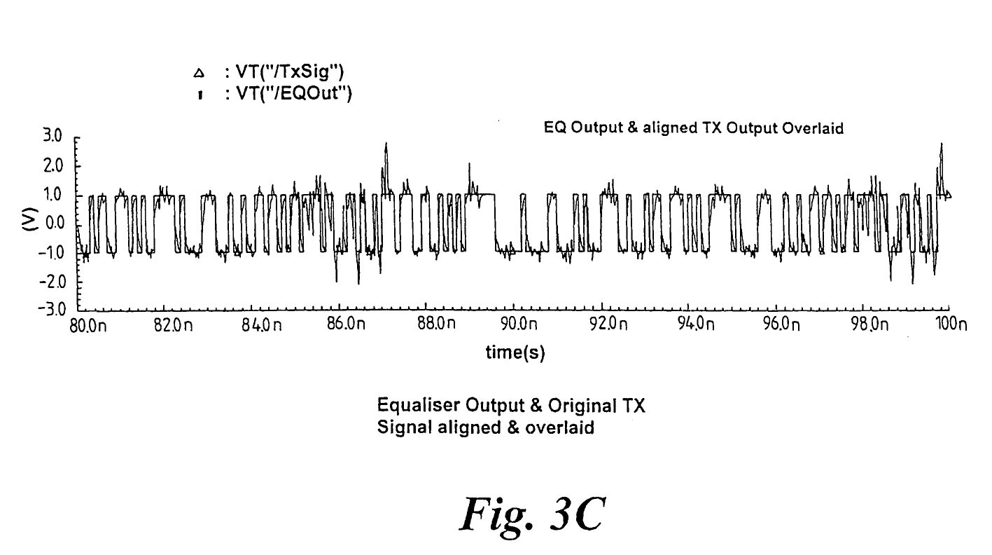

Referring to FIG. 3, FIG. 3B shows the bit stream as present at the input 102 of the DFE 200, whereas FIG. 3C shows the bit stream as originally transmitted overlaid with the output signal from the DFE 200 realigned. For the tap weights employed, it can be seen that the bit stream is almost entirely recovered, meaning that the ISI present in the received bit stream has been almost entirely cancelled out. Consequently, FIG. 3A shows that the second, third, fourth and fifth error signals Err₀₁, Err₀₂, Err₀₃, Err₀₄ are all close to 0 whilst the first error signal, Err₀₀, corresponding to a self-correlation of the bit stream is, on a scale of 0 to 1, at about 0.8. This first error signal Err₀₀, shows that the voltage of the other error signals Err₀₁, Err₀₂, Err₀₃, Err₀₄ are scaled correctly.

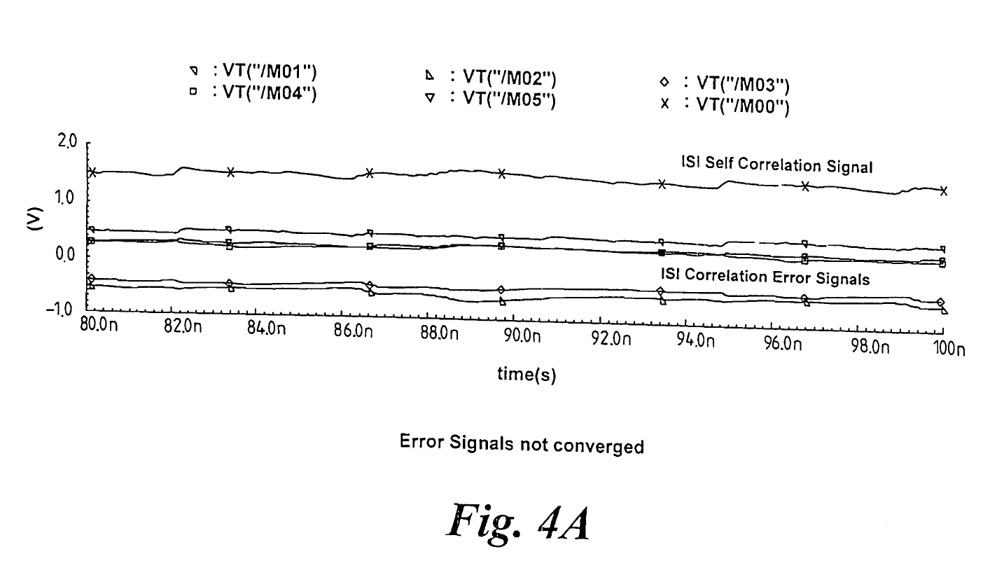

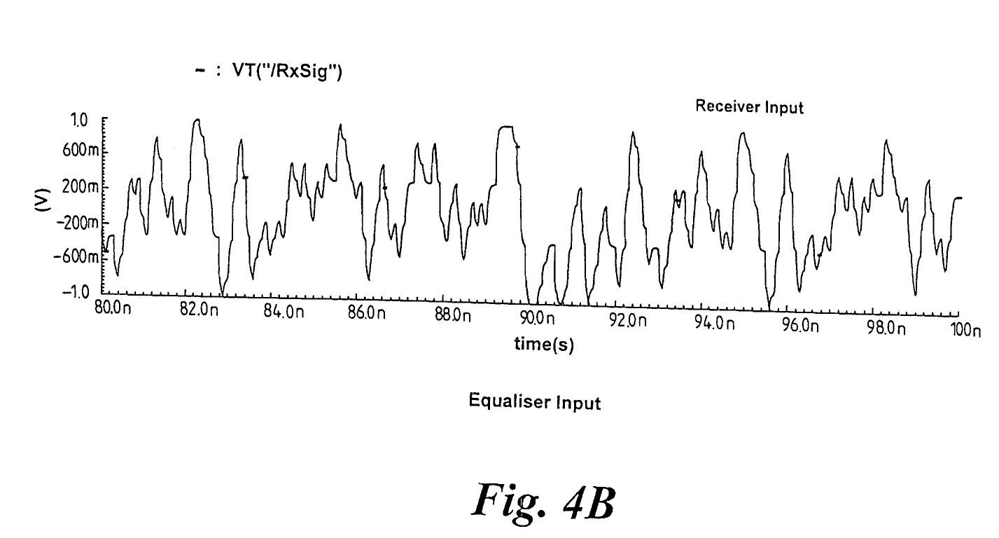

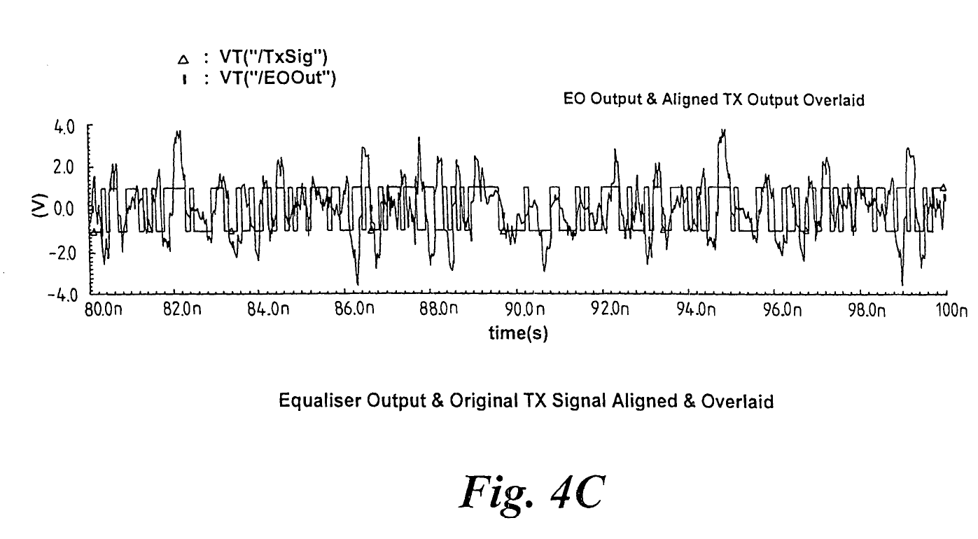

In contrast, and referring to FIG. 4, where the tap weights are partially incorrectly set, it can be seen from FIGS. 4B and 4C that the ISI is much reduced relative to the ISI in the equaliser input signal. However, the error signals of FIG. 4A show a greater spread between themselves than shown in FIG. 3A, demonstrating that the ISI still exists and that optimum tap weights have not yet been employed.

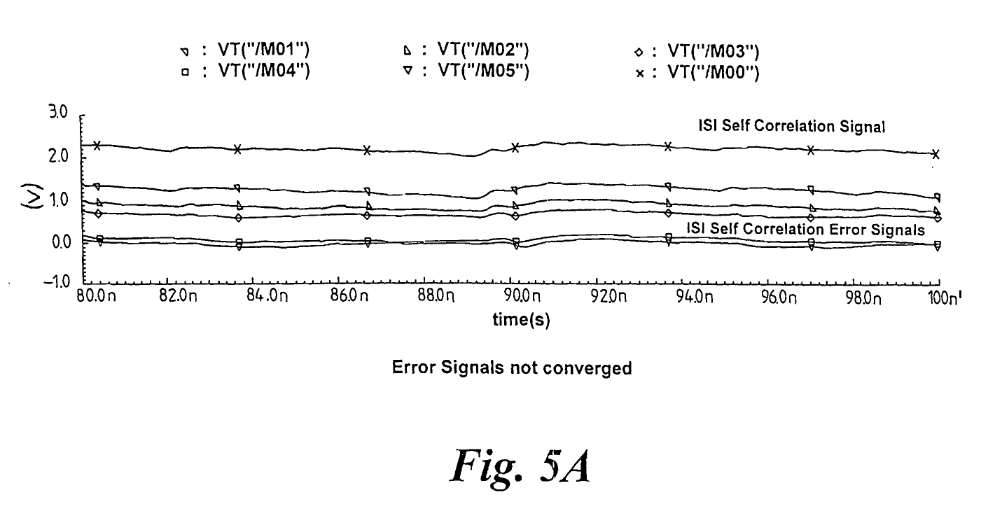

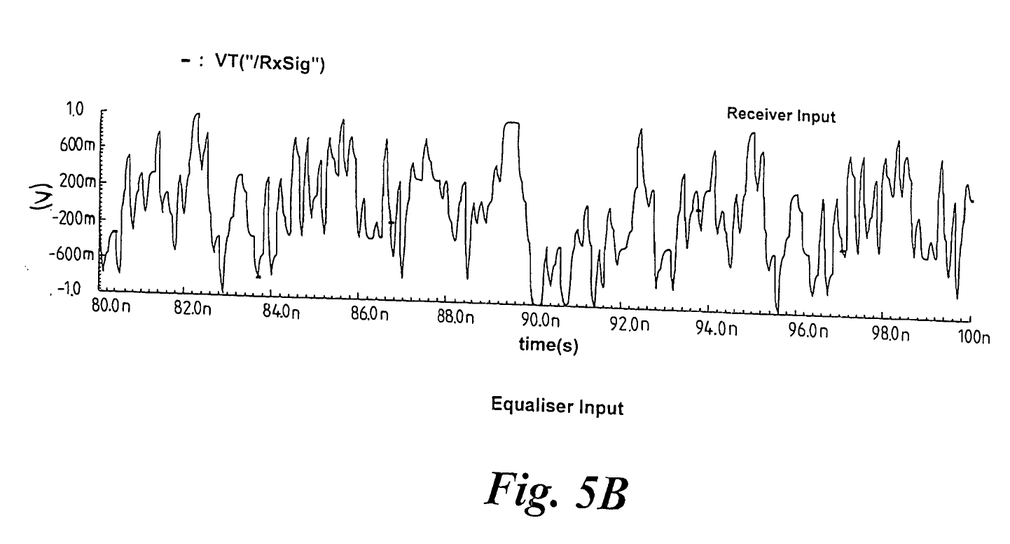

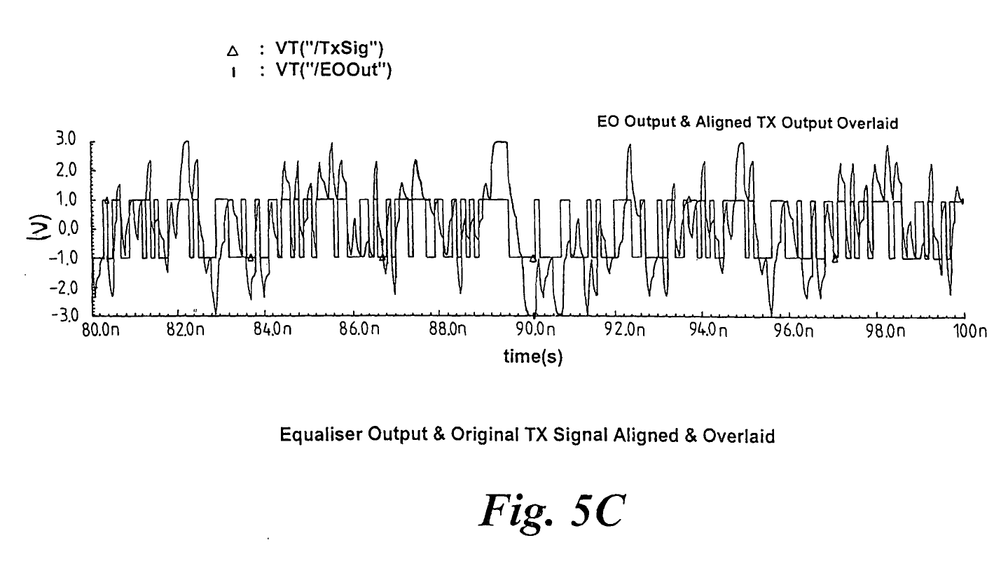

Turning to FIG. 5, no tap weights are applied and the ISI in the equaliser input signal is quite large as can be seen from FIGS. 5B and 5C. However, two error signals are relatively small indicating that little ISI exists between bits that are 4 or 5 unit intervals apart.

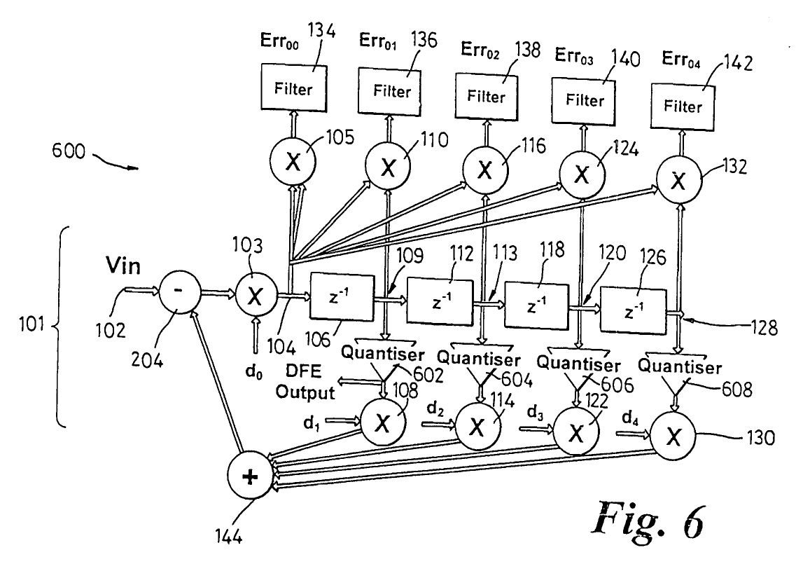

Referring to FIG. 6, an alternative, or variant of the DFE 200 of FIG. 2 constitutes a third embodiment of the invention. The variant DFE 600 differs from the DFE 200 of FIG. 2 in that the quantiser 206 is replaced by the first multiplier 103 and quantisation is now provided by a first quantiser 602 disposed in-circuit between the second tap 109 and the first input of the third multiplier 108, a second quantiser 604 disposed in-circuit between the third tap 113 and the first input of the fifth multiplier 114, a third quantiser 606 disposed in-circuit between the fourth tap 120 and the first input of the seventh multiplier 122, and a fourth quantiser 608 disposed in-circuit between the fifth tap 120 and the first input of the eighth multiplier 130.

A first tap weight, d₀, is provided at the second input of the first multiplier 103 and the DFE output signal is taken from an output of the first quantiser 602.

In operation the variant DFE 600 functions in a very similar way to the DFE 200 of FIG. 2, except that the signal provided at the output of the subtractor 204 is weighted by the first tap weight, d₀, and an unquantised signal is provided to the ISI estimation part of the variant DFE 600. Consequently, quantisation, which is still required for DFEs, is provided at the second, third, fourth and fifth taps 109, 113, 120, 128 by the first, second, third and fourth quantisers 602, 604, 606, 608, respectively. Hence, it is still possible for the third, fifth, seventh and ninth multipliers 108, 114, 122, 130 to receive quantised signals.

As in the example of the DFE 200 of FIG. 2, the DFE is driven by one or more of the second, third, fourth or fifth error signals Err₀₁, Err₀₂, Err₀₃, Err₀₄.

1. A method of measuring Inter-Symbol Interference in a non-wirelessly received bit stream, the method comprising the steps of:
receiving the bit stream;
generating a delayed version of the bit stream; and
correlating bits at a number of bit positions of the received bit stream with bits at a same number of bit positions of the delayed version of the bit stream so as to form an indication of Inter-Symbol Interference.

2. A method as claimed in claim 1, further comprising the step of:
averaging the correlation over a predetermined period of time.

3. A method as claimed in claim 1, wherein the bit stream is a receiver input signal.

4. A method as claimed in claim 2, wherein the bit stream is an equaliser output signal.

5. A method as claimed claim 4, further comprising the step of:
deconvolving the indication of the Inter-Symbol Interference.

6. A method as claimed in claim 5, further comprising the steps of:
generating another delayed version of the bit stream; and
correlating the bits at the number of bit positions of the received bit stream with another same number of bit positions of the another delayed version of the bit stream so as to form another indication of the Inter-Symbol Interference.

7. A method as claimed in claim 6, further comprising the step of:
determining from the indication of the Inter-Symbol Interference and the another indication of the Inter-Symbol Interference, an extent of the Inter-Symbol Interference in terms of the numbers of bits.

8. An Inter-Symbol Interference measurement apparatus comprising:
an apparatus for receiving a bit stream;
a delay for generating a delayed version of the bit stream;
a correlator for correlating bits at a number of bit positions of the received bit stream with bits at a same number of bit positions of the delayed version of the bit stream, the correlation including an indication of Inter-Symbol Interference.

9. An apparatus as claimed in claim 8, wherein the correlator comprises a filter coupled to a multiplier so as to average the correlation over a predetermined period of time.

10. An adaptive equaliser apparatus comprising the Inter-Symbol Interference measurement apparatus as claimed in claim 9.

11. An apparatus as claimed in claim 10, wherein the adaptive equaliser apparatus comprises filter coefficients, the adaptive equaliser apparatus being arranged to adapt the filter coefficients in response to the indication of the Inter-Symbol Interference.

12. An optical receiver comprising the Inter-Symbol Interference measurement apparatus as claimed in claim 8.

13. A method as claimed in claim 1, further comprising the step of:
deconvolving the indication of the Inter-Symbol Interference.

14. A method as claimed in claim 1, further comprising the steps of:
generating another delayed version of the bit stream; and
correlating the bits at the number of bit positions of the received bit stream with another same number of bit positions of the another delayed version of the bit stream so as to form another indication of the Inter-Symbol Interference.

15. An adaptive equaliser apparatus comprising the Inter-Symbol Interference measurement apparatus as claimed in claim 8.
